(19) United States
(12) Patent Application Publication
(10) Pub. No.: US 2019/0350047 A1
(43) Pub. Date: Nov. 14, 2019

(54) USER EQUIPMENT (UE), EVOLVED NODE-B (ENB) AND METHODS TO INDICATE PARAMETERS FOR A RELAY ARRANGEMENT

(71) Applicant: Intel IP Corporation, Santa Clara, CA (US)

(72) Inventors: Changhong Shan, Portland, OR (US); Alexandre Saso Stojanovski, Paris (FR)

(21) Appl. No.: 16/479,161

(22) PCT Filed: Feb. 6, 2018
(86) PCT No.: PCT/US2018/017057

§ 371 Date: Jul. 18, 2019

Related U.S. Application Data
(60) Provisional application No. 62/455,224, filed on Feb. 6, 2017.

(51) Int. Cl. H04W 88/04; H04W 8/00; H04W 8/24; H04W 60/00; H04W 80/02; H04W 76/11; H04W 76/27; H04W 8/08

(52) U.S. Cl. CPC H04W 88/04; H04W 8/005; H04W 8/24; H04W 8/08; H04W 80/02; H04W 76/11; H04W 76/27; H04W 60/00

(57) ABSTRACT

Embodiments of a User Equipment (UE), an Evolved Node-B (eNB) and methods for communication are generally described herein. An eRemote UE may transmit, to an eRelay UE, an eRelay user information request message to request user information from the eRelay UE. The eRemote UE may receive, from the eRelay UE, an eRelay user information response message that includes user information of the eRelay UE. The eRemote UE may transmit, to an eNB, an attach request message that indicates: a request to communicate with the eNB in accordance with a relay arrangement that includes transmission of data packets by the eRemote UE to the eRelay UE to be forwarded to the eNB; whether the relay arrangement is a layer-2 relay arrangement; and at least a portion of the user information of the eRelay UE.

### PRIORITY CLAIM

This application claims priority to U.S. Provisional Patent Application Ser. No. 62/455,224, filed Feb. 6, 2017, which is incorporated herein by reference in its entirety.

### TECHNICAL FIELD

Embodiments pertain to wireless communications. Some embodiments relate to wireless networks including 3GPP (Third Generation Partnership Project) networks, 3GPP LTE (Long Term Evolution) networks, and 3GPP LTE-A (LTE Advanced) networks. Some embodiments relate to Fifth Generation (5G) networks. Some embodiments relate to relay, including layer-2 relay.

### BACKGROUND

Base stations and mobile devices operating in a cellular network may exchange data. Various techniques may be used to improve capacity and/or performance, in some cases, including communication in accordance with new radio (NR) techniques. In an example, a mobile device at a cell edge may experience performance degradation and may benefit from a relay with another mobile device. An overall benefit to the system may also be realized as a result of the relay. Accordingly, there is a general need for methods and systems to perform operations related to handover in these and other scenarios.

### BRIEF DESCRIPTION OF THE DRAWINGS

FIG. 1A is a functional diagram of an example network in accordance with some embodiments;

FIG. 1B is a functional diagram of another example network in accordance with some embodiments;

FIG. 2 illustrates a block diagram of an example machine in accordance with some embodiments;

FIG. 3 illustrates a user device in accordance with some aspects;

FIG. 4 illustrates a base station in accordance with some aspects;

FIG. 5 illustrates an exemplary communication circuitry according to some aspects;

FIG. 6 illustrates the operation of a method of communication in accordance with some embodiments;

FIG. 7 illustrates the operation of another method of communication in accordance with some embodiments;

FIG. 8 illustrates the operation of another method of communication in accordance with some embodiments;

FIG. 9 illustrates example devices that may perform one or more operations in accordance with some embodiments;

FIG. 10A and FIG. 10B illustrate example operations in accordance with some embodiments; and

FIG. 11A and FIG. 11B illustrate example operations in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

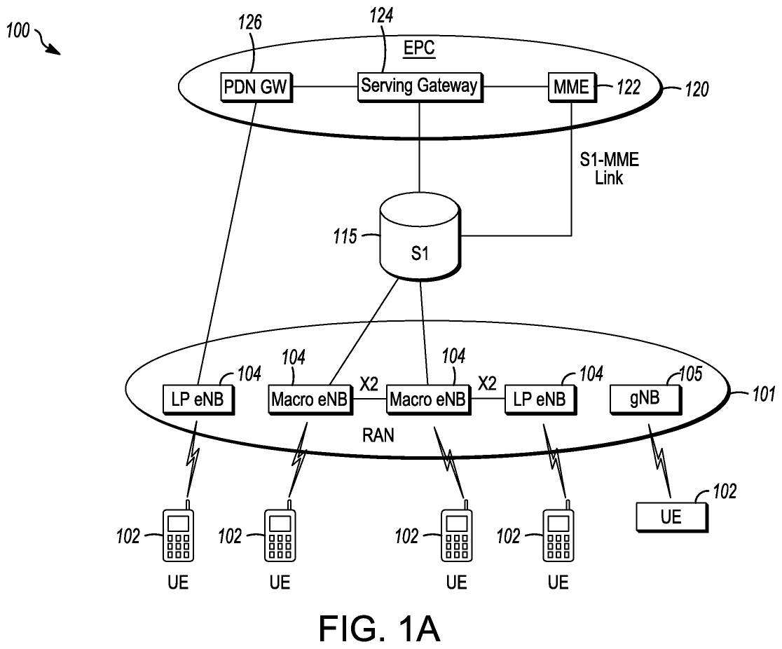

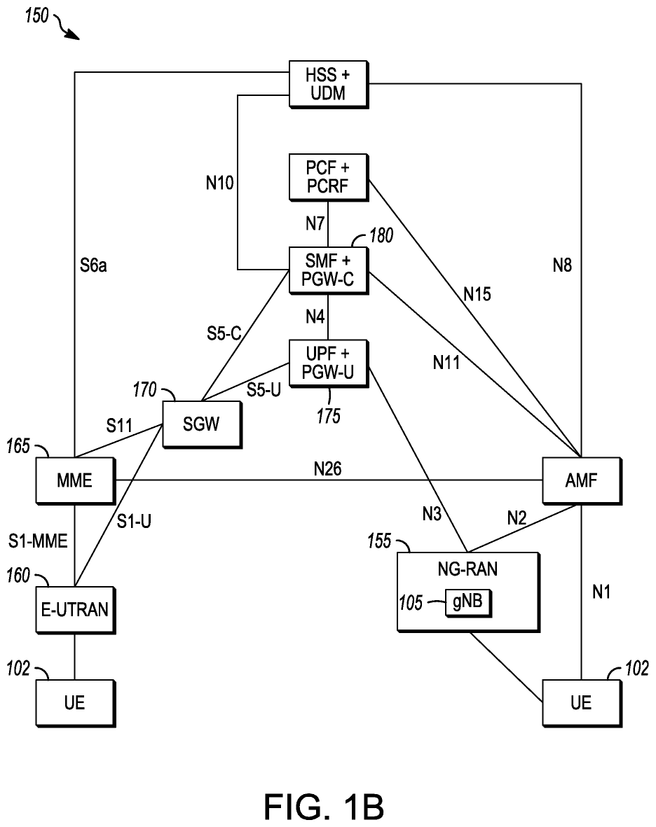

FIG. 1A is a functional diagram of an example network in accordance with some embodiments. FIG. 1B is a functional diagram of another example network in accordance with some embodiments. In some embodiments, the network 100 may be a Third Generation Partnership Project (3GPP) network. In some embodiments, the network 150 may be a 3GPP network. In a non-limiting example, the network 150 may be a new radio (NR) network. It should be noted that embodiments are not limited to usage of 3GPP networks, however, as other networks may be used in some embodiments. As an example, a Fifth Generation (5G) network may be used in some cases. As another example, a New Radio (NR) network may be used in some cases. As another example, a wireless local area network (WLAN) may be used in some cases. Embodiments are not limited to these example networks, however, as other networks may be used in some embodiments. In some embodiments, a network may include one or more components shown in FIG. 1A. Some embodiments may not necessarily include all components shown in FIG. 1A, and some embodiments may include additional components not shown in FIG. 1A. In some embodiments, a network may include one or more components shown in FIG. 1B. Some embodiments may not necessarily include all components shown in FIG. 1B, and some embodiments may include additional components not shown in FIG. 1B. In some embodiments, a network may include one or more components shown in FIG. 1A and one or more components shown in FIG. 1B. In some embodiments, a network may include one or more components shown in FIG. 1A, one or more components shown in FIG. 1B and one or more additional components.

The network 100 may comprise a radio access network (RAN) 101 and the core network 120 (e.g., shown as an evolved packet core (EPC)) coupled together through an S1 interface 115. For convenience and brevity sake, only a portion of the core network 120, as well as the RAN 101, is shown. In a non-limiting example, the RAN 101 may be an evolved universal terrestrial radio access network (E-UTRAN). In another non-limiting example, the RAN 101 may include one or more components of a New Radio (NR) network. In another non-limiting example, the RAN 101 may include one or more components of an E-UTRAN and one or more components of another network (including but not limited to an NR network).

The core network 120 may include a mobility management entity (MME) 122, a serving gateway (serving GW) 124, and packet data network gateway (PDN GW) 126. In some embodiments, the network 100 may include (and/or support) one or more Evolved Node-B's (eNBs) 104 (which may operate as base stations) for communicating with User Equipment (UE) 102. The eNBs 104 may include macro eNBs and low power (LP) eNBs, in some embodiments.

In some embodiments, the network 100 may include (and/or support) one or more Generation Node-B's (gNBs) 105. In some embodiments, one or more eNBs 104 may be configured to operate as gNBs 105. Embodiments are not limited to the number of eNBs 104 shown in FIG. 1A or to the number of gNBs 105 shown in FIG. 1A. In some embodiments, the network 100 may not necessarily include eNBs 104. Embodiments are also not limited to the connectivity of components shown in FIG. 1A.

It should be noted that references herein to an eNB 104 or to a gNB 105 are not limiting. In some embodiments, one or more operations, methods and/or techniques (such as those described herein) may be practiced by a base station component (and/or other component), including but not limited to a gNB 105, an eNB 104, a serving cell, a transmit receive point (TRP) and/or other. In some embodiments, the base station component may be configured to operate in accordance with a New Radio (NR) protocol and/or NR standard, although the scope of embodiments is not limited in this respect. In some embodiments, the base station component may be configured to operate in accordance with a Fifth Generation (5G) protocol and/or 5G standard, although the scope of embodiments is not limited in this respect.

In some embodiments, one or more of the UEs 102 and/or eNBs 104 may be configured to operate in accordance with an NR protocol and/or NR techniques. References to a UE 102, eNB 104 and/or gNB 105 as part of descriptions herein are not limiting. For instance, descriptions of one or more operations, techniques and/or methods practiced by a gNB 105 are not limiting. In some embodiments, one or more of those operations, techniques and/or methods may be practiced by an eNB 104 and/or other base station component.

In some embodiments, the UE 102 may transmit signals (data, control and/or other) to the gNB 105, and may receive signals (data, control and/or other) from the gNB 105. In some embodiments, the UE 102 may transmit signals (data, control and/or other) to the eNB 104, and may receive signals (data, control and/or other) from the eNB 104. These embodiments will be described in more detail below.

The MME 122 is similar in function to the control plane of legacy Serving GPRS Support Nodes (SGSN). The MME 122 manages mobility aspects in access such as gateway selection and tracking area list management. The serving GW 124 terminates the interface toward the RAN 101, and routes data packets between the RAN 101 and the core network 120. In addition, it may be a local mobility anchor point for inter-eNB handovers and also may provide an anchor for inter-3GPP mobility. Other responsibilities may include lawful intercept, charging, and some policy enforcement. The serving GW 124 and the MME 122 may be implemented in one physical node or separate physical nodes. The PDN GW 126 terminates an SGi interface toward the packet data network (PDN). The PDN GW 126 routes data packets between the EPC 120 and the external PDN, and may be a key node for policy enforcement and charging data collection. It may also provide an anchor point for mobility with non-LTE accesses. The external PDN can be any kind of IP network, as well as an IP Multimedia Subsystem (IMS) domain. The PDN GW 126 and the serving GW 124 may be implemented in one physical node or separated physical nodes.

In some embodiments, the eNBs 104 (macro and micro) terminate the air interface protocol and may be the first point of contact for a UE 102. In some embodiments, an eNB 104 may fulfill various logical functions for the network 100, including but not limited to RNC (radio network controller functions) such as radio bearer management, uplink and downlink dynamic radio resource management and data packet scheduling, and mobility management.

In some embodiments, UEs 102 may be configured to communicate Orthogonal Frequency Division Multiplexing (OFDM) communication signals with an eNB 104 and/or gNB 105 over a multicarrier communication channel in accordance with an Orthogonal Frequency Division Multiple Access (OFDMA) communication technique. In some embodiments, eNBs 104 and/or gNBs 105 may be configured to communicate OFDM communication signals with a UE 102 over a multicarrier communication channel in accordance with an OFDMA communication technique. The OFDM signals may comprise a plurality of orthogonal subcarriers.

The S1 interface 115 is the interface that separates the RAN 101 and the EPC 120. It may be split into two parts: the S1-U, which carries traffic data between the eNBs 104 and the serving GW 124, and the S1-MME, which is a signaling interface between the eNBs 104 and the MME 122. The X2 interface is the interface between eNBs 104. The X2 interface comprises two parts, the X2-C and X2-U. The X2-C is the control plane interface between the eNBs 104, while the X2-U is the user plane interface between the eNBs 104.

In some embodiments, similar functionality and/or connectivity described for the eNB 104 may be used for the gNB 105, although the scope of embodiments is not limited in this respect. In a non-limiting example, the S1 interface 115 (and/or similar interface) may be split into two parts: the S1-U, which carries traffic data between the gNBs 105 and the serving GW 124, and the S1-MME, which is a signaling interface between the gNBs 104 and the MME 122. The X2 interface (and/or similar interface) may enable communication between eNBs 104, communication between gNBs 105 and/or communication between an eNB 104 and a gNB 105.

With cellular networks, LP cells are typically used to extend coverage to indoor areas where outdoor signals do not reach well, or to add network capacity in areas with very dense phone usage, such as train stations. As used herein, the term low power (LP) eNB refers to any suitable relatively low power eNB for implementing a narrower cell (narrower than a macro cell) such as a femtocell, a picocell, or a micro cell. Femtocell eNBs are typically provided by a mobile network operator to its residential or enterprise customers. A femtocell is typically the size of a residential gateway or smaller and generally connects to the user's broadband line. Once plugged in, the femtocell connects to the mobile operator's mobile network and provides extra coverage in a range of typically 30 to 50 meters for residential femtocells. Thus, a LP eNB might be a femtocell eNB since it is coupled through the PDN GW 126. Similarly, a picocell is a wireless communication system typically covering a small area, such as in-building (offices, shopping malls, train stations, etc.), or more recently in-aircraft. A picocell eNB can generally connect through the X2 link to another eNB such as a macro eNB through its base station controller (BSC) functionality. Thus, LP eNB may be implemented with a picocell eNB since it is coupled to a macro eNB via an X2 interface. Picocell eNBs or other LP eNBs may incorporate some or all functionality of a macro eNB. In some cases, this may be referred to as an access point base station or enterprise femtocell. In some embodiments, various types of gNBs 105 may be used, including but not limited to one or more of the eNB types described above.

In some embodiments, the network 150 may include one or more components configured to operate in accordance with one or more 3GPP standards, including but not limited to an NR standard. The network 150 shown in FIG. 1B may include a next generation RAN (NG-RAN) 155, which may include one or more gNBs 105. In some embodiments, the network 150 may include the E-UTRAN 160, which may include one or more eNBs. The E-UTRAN 160 may be similar to the RAN 101 described herein, although the scope of embodiments is not limited in this respect.

In some embodiments, the network 150 may include the MME 165. The MME 165 may be similar to the MME 122 described herein, although the scope of embodiments is not limited in this respect. The MME 165 may perform one or more operations or functionality similar to those described herein regarding the MME 122, although the scope of embodiments is not limited in this respect.

In some embodiments, the network 150 may include the SGW 170. The SGW 170 may be similar to the SGW 124 described herein, although the scope of embodiments is not limited in this respect. The SGW 170 may perform one or more operations or functionality similar to those described herein regarding the SGW 124, although the scope of embodiments is not limited in this respect.

In some embodiments, the network 150 may include component(s) and/or module(s) for functionality for a user plane function (UPF) and user plane functionality for PGW (PGW-U), as indicated by 175. some embodiments, the network 150 may include component(s) and/or module(s) for functionality for a session management function (SMF) and control plane functionality for PGW (PGW-C), as indicated by 180. In some embodiments, the component(s) and/or module(s) indicated by 175 and/or 180 may be similar to the PGW 126 described herein, although the scope of embodiments is not limited in this respect. The the component(s) and/or module(s) indicated by 175 and/or 180 may perform one or more operations or functionality similar to those described herein regarding the PGW 126, although the scope of embodiments is not limited in this respect. One or both of the components 170, 172 may perform at least a portion of the functionality described herein for the PGW 126, although the scope of embodiments is not limited in this respect.

Embodiments are not limited to the number or type of components shown in FIG. 1B. Embodiments are also not limited to the connectivity of components shown in FIG. 1B.

In some embodiments, a downlink resource grid may be used for downlink transmissions from an eNB 104 to a UE 102, while uplink transmission from the UE 102 to the eNB 104 may utilize similar techniques. In some embodiments, a downlink resource grid may be used for downlink transmissions from a gNB 105 to a UE 102, while uplink transmission from the UE 102 to the gNB 105 may utilize similar techniques. The grid may be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid correspond to one OFDM symbol and one OFDM subcarrier, respectively. The duration of the resource grid in the time domain corresponds to one slot in a radio frame. The smallest time-frequency unit in a resource grid is denoted as a resource element (RE). There are several different physical downlink channels that are conveyed using such resource blocks. With particular relevance to this disclosure, two of these physical downlink channels are the physical downlink shared channel and the physical down link control channel.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware. Embodiments described herein may be implemented into a system using any suitably configured hardware and/or software.

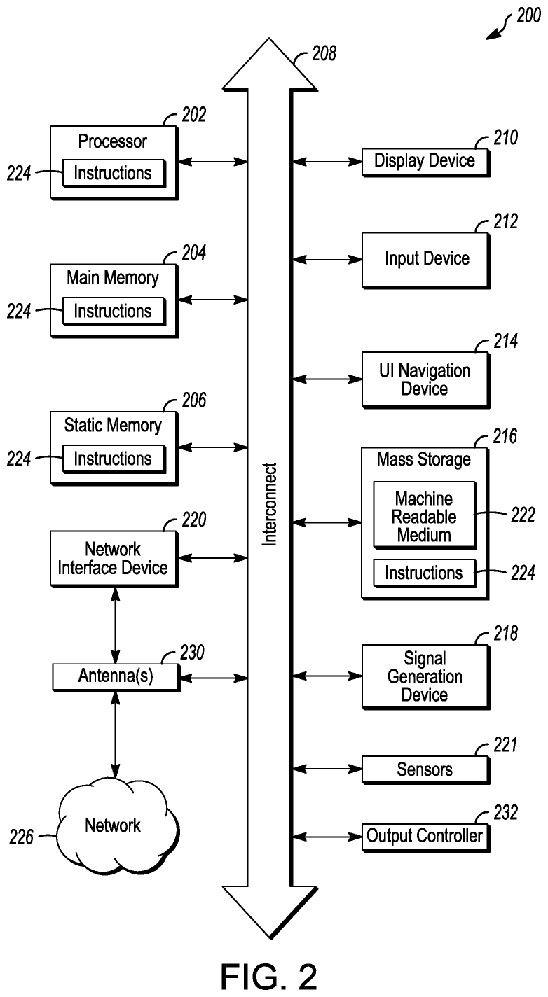

FIG. 2 illustrates a block diagram of an example machine in accordance with some embodiments. The machine 200 is an example machine upon which any one or more of the techniques and/or methodologies discussed herein may be performed. In alternative embodiments, the machine 200 may operate as a standalone device or may be connected (e.g., networked) to other machines. In a networked deployment, the machine 200 may operate in the capacity of a server machine, a client machine, or both in server-client network environments. In an example, the machine 200 may act as a peer machine in peer-to-peer (P2P) (or other distributed) network environment. The machine 200 may be a UE 102, eNB 104, gNB 105, access point (AP), station (STA), user, device, mobile device, base station, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The machine (e.g., computer system) 200 may include a hardware processor 202 (e.g., a central processing unit (CPU), a graphics processing unit (GPU), a hardware processor core, or any combination thereof), a main memory 204 and a static memory 206, some or all of which may communicate with each other via an interlink (e.g., bus) 208. The machine 200 may further include a display unit 210, an alphanumeric input device 212 (e.g., a keyboard), and a user interface (UI) navigation device 214 (e.g., a mouse). In an example, the display unit 210, input device 212 and UI navigation device 214 may be a touch screen display. The machine 200 may additionally include a storage device (e.g., drive unit) 216, a signal generation device 218 (e.g., a speaker), a network interface device 220, and one or more sensors 221, such as a global positioning system (GPS) sensor, compass, accelerometer, or other sensor. The machine 200 may include an output controller 228, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a machine readable medium 222 on which is stored one or more sets of data structures or instructions 224 (e.g., software) embodying or utilized by any one or more of the techniques or functions described herein. The instructions 224 may also reside, completely or at least partially, within the main memory 204, within static memory 206, or within the hardware processor 202 during execution thereof by the machine 200. In an example, one or any combination of the hardware processor 202, the main memory 204, the static memory 206, or the storage device 216 may constitute machine readable media. In some embodiments, the machine readable medium may be or may include a non-transitory computer-readable storage medium. In some embodiments, the machine readable medium may be or may include a computer-readable storage medium.

While the machine readable medium 222 is illustrated as a single medium, the term “machine readable medium” may include a single medium or multiple media (e.g., a centralized or distributed database, and/or associated caches and servers) configured to store the one or more instructions 224. The term “machine readable medium” may include any medium that is capable of storing, encoding, or carrying instructions for execution by the machine 200 and that cause the machine 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 224 may further be transmitted or received over a communications network 226 using a transmission medium via the network interface device 220 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 220 may include one or more physical jacks (e.g., Ethernet, coaxial, or phone jacks) or one or more antennas to connect to the communications network 226. In an example, the network interface device 220 may include a plurality of antennas to wirelessly communicate using at least one of single-input multiple-output (SIMO), multiple-input multiple-output (MIMO), or multiple-input single-output (MISO) techniques. In some examples, the network interface device 220 may wirelessly communicate using Multiple User MIMO techniques. The term “transmission medium” shall be taken to include any intangible medium that is capable of storing, encoding or carrying instructions for execution by the machine 200, and includes digital or analog communications signals or other intangible medium to facilitate communication of such software.

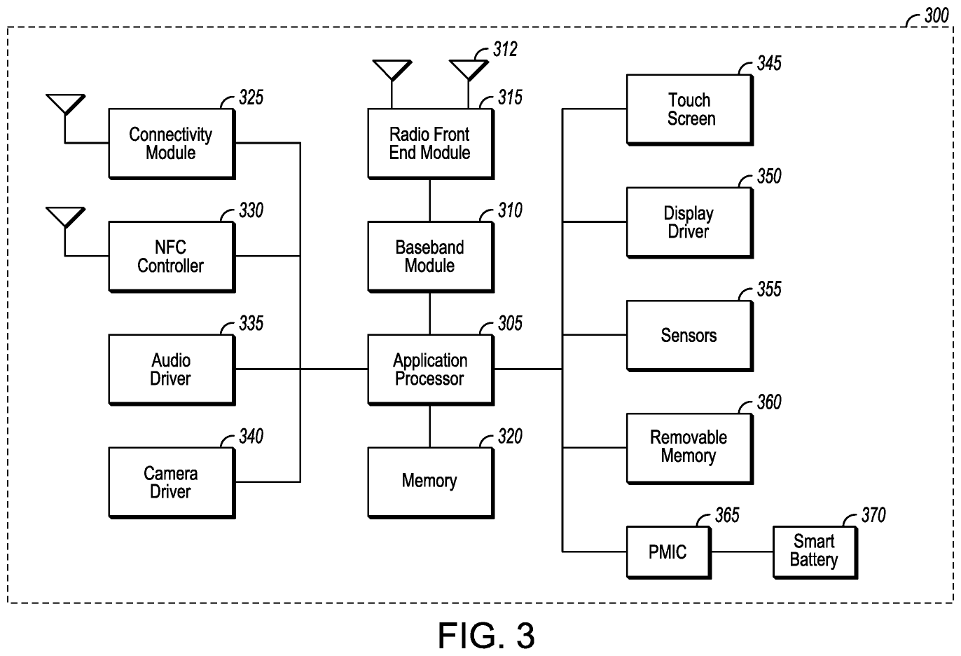

FIG. 3 illustrates a user device in accordance with some aspects. In some embodiments, the user device 300 may be a mobile device. In some embodiments, the user device 300 may be or may be configured to operate as a User Equipment (UE). In some embodiments, the user device 300 may be arranged to operate in accordance with a new radio (NR) protocol. In some embodiments, the user device 300 may be arranged to operate in accordance with a Third Generation Partnership Protocol (3GPP) protocol. The user device 300 may be suitable for use as a UE 102 as depicted in FIG. 1, in some embodiments. It should be noted that in some embodiments, a UE, an apparatus of a UE, a user device or an apparatus of a user device may include one or more of the components shown in one or more of FIGS. 2, 3, and 5. In some embodiments, such a UE, user device and/or apparatus may include one or more additional components.

In some aspects, the user device 300 may include an application processor 305, baseband processor 310 (also referred to as a baseband module), radio front end module (RFEM) 315, memory 320, connectivity module 325, near field communication (NFC) controller 330, audio driver 335, camera driver 340, touch screen 345, display driver 350, sensors 355, removable memory 360, power management integrated circuit (PMIC) 365 and smart battery 370. In some aspects, the user device 300 may be a User Equipment (UE).

In some aspects, application processor 305 may include, for example, one or more CPU cores and one or more of cache memory, low drop-out voltage regulators (LDOs), interrupt controllers, serial interfaces such as serial peripheral interface (SPI), inter-integrated circuit (I²C) or universal programmable serial interface module, real time clock (RTC), timer-counters including interval and watchdog timers, general purpose input-output (IO), memory card controllers such as secure digital/multi-media card (SD/MMC) or similar, universal serial bus (USB) interfaces, mobile industry processor interface (MIPI) interfaces and Joint Test Access Group (JTAG) test access ports.

In some aspects, baseband module 310 may be implemented, for example, as a solder-down substrate including one or more integrated circuits, a single packaged integrated circuit soldered to a main circuit board, and/or a multi-chip module containing two or more integrated circuits.

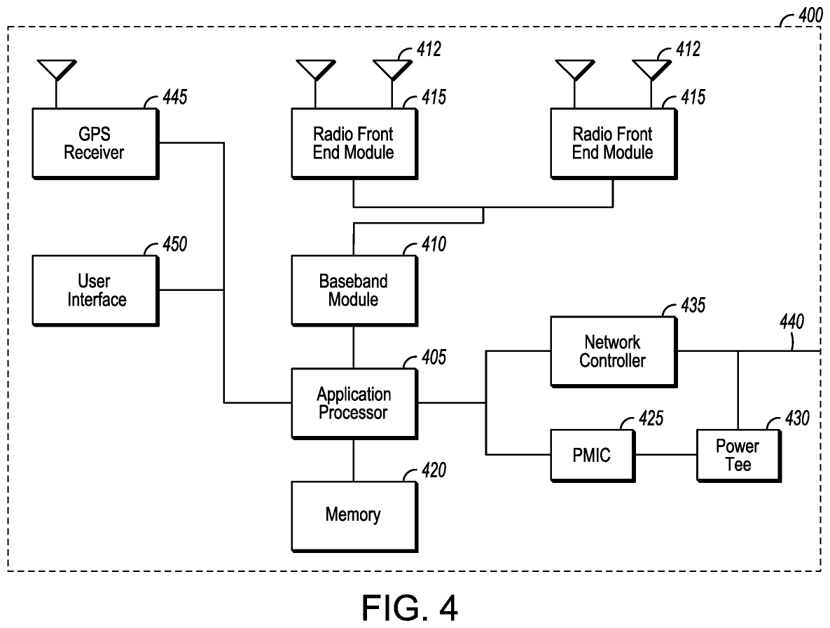

FIG. 4 illustrates a base station in accordance with some aspects. In some embodiments, the base station 400 may be or may be configured to operate as an Evolved Node-B (eNB). In some embodiments, the base station 400 may be or may be configured to operate as a Generation Node-B (gNB). In some embodiments, the base station 400 may be arranged to operate in accordance with a new radio (NR) protocol. In some embodiments, the base station 400 may be arranged to operate in accordance with a Third Generation Partnership Protocol (3GPP) protocol. It should be noted that in some embodiments, the base station 400 may be a stationary non-mobile device. The base station 400 may be suitable for use as an eNB 104 as depicted in FIG. 1, in some embodiments. The base station 400 may be suitable for use as a gNB 105 as depicted in FIG. 1, in some embodiments. It should be noted that in some embodiments, an eNB, an apparatus of an eNB, a gNB, an apparatus of a gNB, a base station and/or an apparatus of a base station may include one or more of the components shown in one or more of FIGS. 2, 4, and 5. In some embodiments, such an eNB, gNB, base station and/or apparatus may include one or more additional components.

FIG. 4 illustrates a base station or infrastructure equipment radio head 400 in accordance with an aspect. The base station 400 may include one or more of application processor 405, baseband modules 410, one or more radio front end modules 415, memory 420, power management circuitry 425, power tee circuitry 430, network controller 435, network interface connector 440, satellite navigation receiver module 445, and user interface 450. In some aspects, the base station 400 may be an Evolved Node-B (eNB), which may be arranged to operate in accordance with a 3GPP protocol, new radio (NR) protocol and/or Fifth Generation (5G) protocol. In some aspects, the base station 400 may be a generation Node-B (gNB), which may be arranged to operate in accordance with a 3GPP protocol, new radio (NR) protocol and/or Fifth Generation (5G) protocol.

In some aspects, application processor 405 may include one or more CPU cores and one or more of cache memory, low drop-out voltage regulators (LDOs), interrupt controllers, serial interfaces such as SPI, I²C or universal programmable serial interface module, real time clock (RTC), timer-counters including interval and watchdog timers, general purpose IO, memory card controllers such as SD/MMC or similar, USB interfaces, MIPI interfaces and Joint Test Access Group (JTAG) test access ports.

In some aspects, baseband processor 410 may be implemented, for example, as a solder-down substrate including one or more integrated circuits, a single packaged integrated circuit soldered to a main circuit board or a multi-chip module containing two or more integrated circuits.

In some aspects, memory 420 may include one or more of volatile memory including dynamic random access memory (DRAM) and/or synchronous dynamic random access memory (SDRAM), and nonvolatile memory (NVM) including high-speed electrically erasable memory (commonly referred to as Flash memory), phase change random access memory (PRAM), magneto-resistive random access memory (MRAM) and/or a three-dimensional cross-point memory. Memory 420 may be implemented as one or more of solder down packaged integrated circuits, socketed memory modules and plug-in memory cards.

In some aspects, power management integrated circuitry 425 may include one or more of voltage regulators, surge protectors, power alarm detection circuitry and one or more backup power sources such as a battery or capacitor. Power alarm detection circuitry may detect one or more of brown out (under-voltage) and surge (over-voltage) conditions.

In some aspects, power tee circuitry 430 may provide for electrical power drawn from a network cable to provide both power supply and data connectivity to the base station 400 using a single cable. In some aspects, network controller 435 may provide connectivity to a network using a standard network interface protocol such as Ethernet. Network connectivity may be provided using a physical connection which is one of electrical (commonly referred to as copper interconnect), optical or wireless.

In some aspects, satellite navigation receiver module 445 may include circuitry to receive and decode signals transmitted by one or more navigation satellite constellations such as the global positioning system (GPS), Globalnaya Navigatsionnaya Sputnikovaya Sistema (GLONASS), Galileo and/or BeiDou. The receiver 445 may provide data to application processor 405 which may include one or more of position data or time data. Application processor 405 may use time data to synchronize operations with other radio base stations. In some aspects, user interface 450 may include one or more of physical or virtual buttons, such as a reset button, one or more indicators such as light emitting diodes (LEDs) and a display screen.

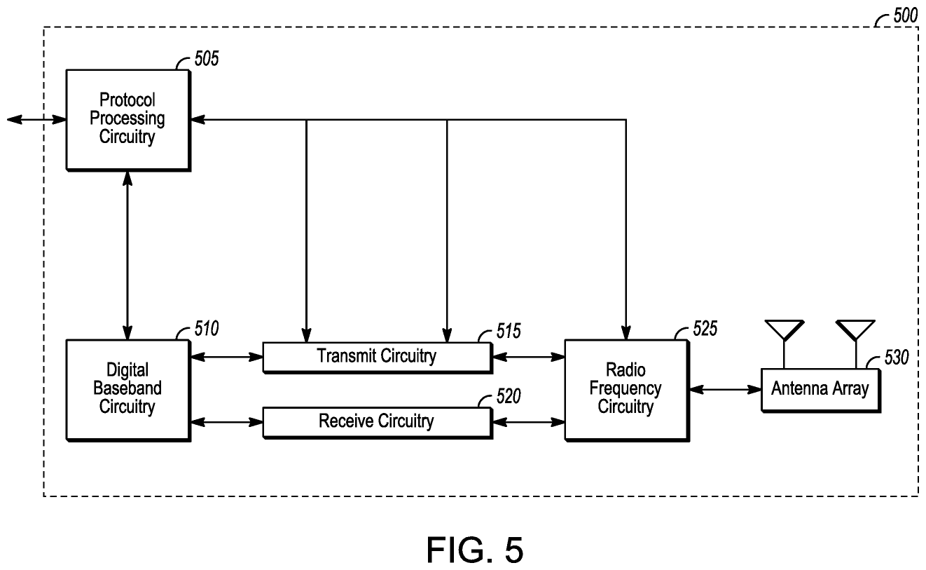

FIG. 5 illustrates an exemplary communication circuitry according to some aspects. Circuitry 500 is alternatively grouped according to functions. Components as shown in 500 are shown here for illustrative purposes and may include other components not shown here in FIG. 5. In some aspects, the communication circuitry 500 may be used for millimeter wave communication, although aspects are not limited to millimeter wave communication. Communication at any suitable frequency may be performed by the communication circuitry 500 in some aspects.

It should be noted that a device, such as a UE 102, eNB 104, gNB 105, the user device 300, the base station 400, the machine 200 and/or other device may include one or more components of the communication circuitry 500, in some aspects.

The communication circuitry 500 may include protocol processing circuitry 505, which may implement one or more of medium access control (MAC), radio link control (RLC), packet data convergence protocol (PDCP), radio resource control (RRC) and non-access stratum (NAS) functions. Protocol processing circuitry 505 may include one or more processing cores (not shown) to execute instructions and one or more memory structures (not shown) to store program and data information.

The communication circuitry 500 may further include digital baseband circuitry 510, which may implement physical layer (PHY) functions including one or more of hybrid automatic repeat request (HARQ) functions, scrambling and/or descrambling, coding and/or decoding, layer mapping and/or de-mapping, modulation symbol mapping, received symbol and/or bit metric determination, multi-antenna port pre-coding and/or decoding which may include one or more of space-time, space-frequency or spatial coding, reference signal generation and/or detection, preamble sequence generation and/or decoding, synchronization sequence generation and/or detection, control channel signal blind decoding, and other related functions.

The communication circuitry 500 may further include transmit circuitry 515, receive circuitry 520 and/or antenna array circuitry 530. The communication circuitry 500 may further include radio frequency (RF) circuitry 525. In an aspect of the disclosure, RF circuitry 525 may include multiple parallel RF chains for one or more of transmit or receive functions, each connected to one or more antennas of the antenna array 530.

In an aspect of the disclosure, protocol processing circuitry 505 may include one or more instances of control circuitry (not shown) to provide control functions for one or more of digital baseband circuitry 510, transmit circuitry 515, receive circuitry 520, and/or radio frequency circuitry 525

In some embodiments, processing circuitry may perform one or more operations described herein and/or other operation(s). In a non-limiting example, the processing circuitry may include one or more components such as the processor 202, application processor 305, baseband module 310, application processor 405, baseband module 410, protocol processing circuitry 505, digital baseband circuitry 510, similar component(s) and/or other component(s).

In some embodiments, a transceiver may transmit one or more elements (including but not limited to those described herein) and/or receive one or more elements (including but not limited to those described herein). In a non-limiting example, the transceiver may include one or more components such as the radio front end module 315, radio front end module 415, transmit circuitry 515, receive circuitry 520, radio frequency circuitry 525, similar component(s) and/or other component(s).

One or more antennas (such as 230, 312, 412, 530 and/or others) may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, one or more of the antennas (such as 230, 312, 412, 530 and/or others) may be effectively separated to take advantage of spatial diversity and the different channel characteristics that may result.

In some embodiments, the UE 102, eNB 104, gNB 105, user device 300, base station 400, machine 200 and/or other device described herein may be a mobile device and/or portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a wearable device such as a medical device (e.g., a heart rate monitor, a blood pressure monitor, etc.), or other device that may receive and/or transmit information wirelessly. In some embodiments, the UE 102, eNB 104, gNB 105, user device 300, base station 400, machine 200 and/or other device described herein may be configured to operate in accordance with 3GPP standards, although the scope of the embodiments is not limited in this respect. In some embodiments, the UE 102, eNB 104, gNB 105, user device 300, base station 400, machine 200 and/or other device described herein may be configured to operate in accordance with new radio (NR) standards, although the scope of the embodiments is not limited in this respect. In some embodiments, the UE 102, eNB 104, gNB 105, user device 300, base station 400, machine 200 and/or other device described herein may be configured to operate according to other protocols or standards, including IEEE 802.11 or other IEEE standards. In some embodiments, the UE 102, eNB 104, gNB 105, user device 300, base station 400, machine 200 and/or other device described herein may include one or more of a keyboard, a display, a non-volatile memory port, multiple antennas, a graphics processor, an application processor, speakers, and other mobile device elements. The display may be an LCD screen including a touch screen.

Although the UE 102, eNB 104, gNB 105, user device 300, base station 400, machine 200 and/or other device described herein may each be illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

It should be noted that in some embodiments, an apparatus used by the UE 102, eNB 104, gNB 105, machine 200, user device 300 and/or base station 400 may include various components shown in FIGS. 2-5. Accordingly, techniques and operations described herein that refer to the UE 102 may be applicable to an apparatus of a UE. In addition, techniques and operations described herein that refer to the eNB 104 may be applicable to an apparatus of an eNB. In addition, techniques and operations described herein that refer to the gNB 105 may be applicable to an apparatus of a gNB.

In accordance with some embodiments, a UE 102 may be configurable to operate as an eRemote UE 102. The eRemote UE 102 may transmit, to an eRelay UE 102, an eRelay user information request message to request user information from the eRelay UE 102. The eRemote UE 102 may receive, from the eRelay UE 102, an eRelay user information response message that includes user information of the eRelay UE 102. The eRemote UE 102 may transmit, to an eNB 104, an attach request message that indicates: a request to communicate with the eNB 104 in accordance with a relay arrangement that includes transmission of data packets by the eRemote UE 102 to the eRelay UE 102 to be forwarded to the eNB 104; whether the relay arrangement is a layer-2 relay arrangement; and at least a portion of the user information of the eRelay UE 102. These embodiments are described in more detail below.

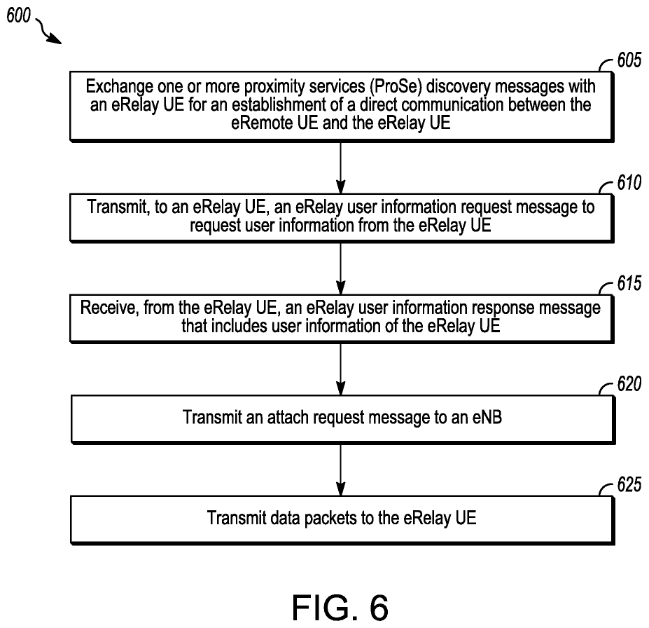

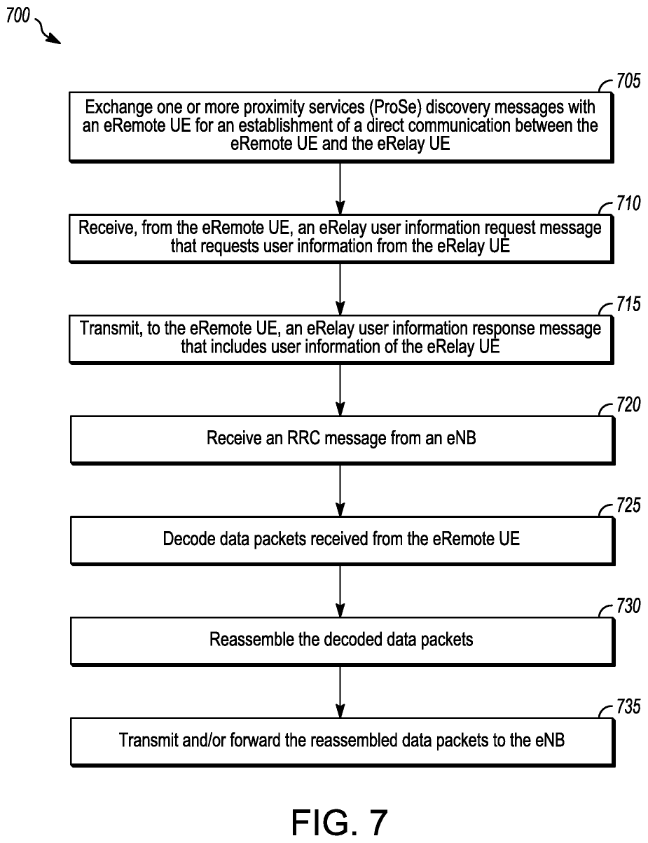

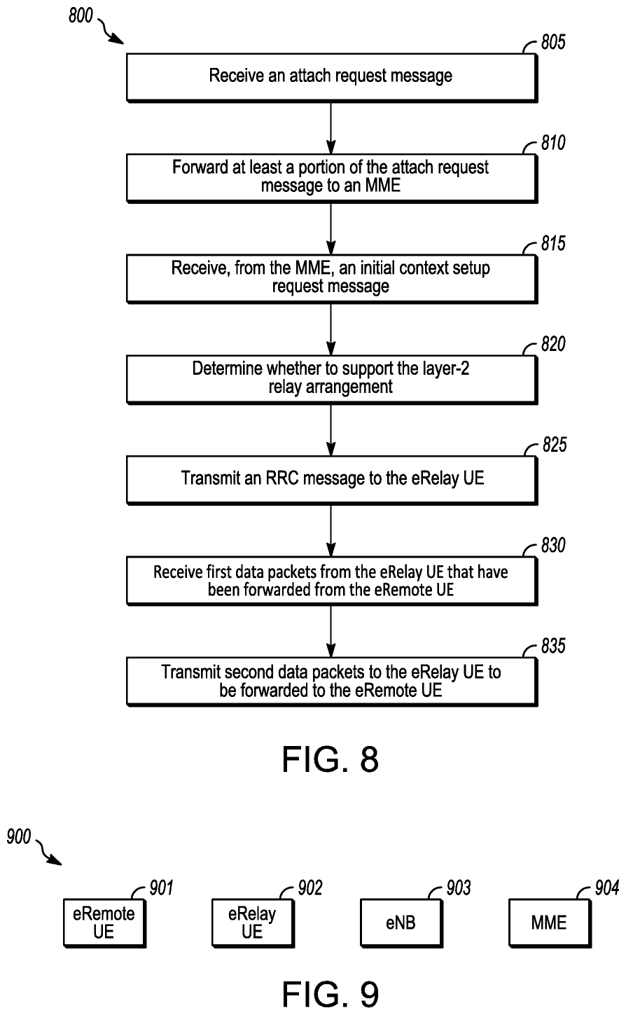

FIG. 6 illustrates the operation of a method of communication in accordance with some embodiments. FIG. 7 illustrates the operation of another method of communication in accordance with some embodiments. FIG. 8 illustrates the operation of another method of communication in accordance with some embodiments. It is important to note that embodiments of the methods 600, 700, 800 may include additional or even fewer operations or processes in comparison to what is illustrated in FIGS. 6-8. In addition, embodiments of the methods 600, 700, 800 are not necessarily limited to the chronological order that is shown in FIGS. 6-8. In describing the methods 600, 700, 800, reference may be made to one or more figures, although it is understood that the methods 600, 700, 800 may be practiced with any other suitable systems, interfaces and components.

In some embodiments, a UE 102 may perform one or more operations of the method 600, but embodiments are not limited to performance of the method 600 and/or operations of it by the UE 102. In some embodiments, another device and/or component may perform one or more operations of the method 600. In some embodiments, another device and/or component may perform one or more operations that may be similar to one or more operations of the method 600. In some embodiments, another device and/or component may perform one or more operations that may be reciprocal to one or more operations of the method 600. In some embodiments, a UE 102 may be configurable to operate as an eRemote UE, and may perform one or more operations of the method 600.

In some embodiments, a UE 102 may perform one or more operations of the method 700, but embodiments are not limited to performance of the method 700 and/or operations of it by the UE 102. In some embodiments, another device and/or component may perform one or more operations of the method 700. In some embodiments, another device and/or component may perform one or more operations that may be similar to one or more operations of the method 700. In some embodiments, another device and/or component may perform one or more operations that may be reciprocal to one or more operations of the method 700. In some embodiments, a UE 102 may be configurable to operate as an eRelay UE, and may perform one or more operations of the method 700.

In some embodiments, an eNB 104 may perform one or more operations of the method 800, but embodiments are not limited to performance of the method 800 and/or operations of it by the eNB 104. In some embodiments, another device and/or component may perform one or more operations of the method 800. In some embodiments, another device and/or component may perform one or more operations that may be similar to one or more operations of the method 800. In some embodiments, another device and/or component may perform one or more operations that may be reciprocal to one or more operations of the method 800.

It should be noted that one or more operations of one of the methods 600, 700, 800 may be the same as, similar to and/or reciprocal to one or more operations of the other methods. For instance, an operation of the method 600 may be the same as, similar to and/or reciprocal to an operation of the method 700, in some embodiments. In a non-limiting example, an operation of the method 600 may include transmission of an element (such as a frame, block, message and/or other) by the eRemote UE 102 to the eRelay UE 902, and an operation of the method 700 may include reception of a same element (and/or similar element) by the eRelay UE 902 from the eRemote UE 102. In some cases, descriptions of operations and techniques described as part of one of the methods 600, 700, 800 may be relevant to one or both of the other methods.

Discussion of various techniques and concepts regarding one of the methods 600, 700, 800 and/or other method may be applicable to one of the other methods, although the scope of embodiments is not limited in this respect. Such technique and concepts may include eRemote UE, eRelay UE, various messages, parameters included in the messages, layer-2 relay and/or other.

In descriptions of the methods 600, 700, 800, references to an eRemote UE and/or eRelay UE may be used for clarity, but the scope of embodiments is not limited by those references. In some embodiments, a UE 102 may be configurable to operate as either an eRemote UE or as an eRelay UE, although the scope of embodiments is not limited in this respect.

The methods 600, 700, 800 and other methods described herein may refer to eNBs 104, gNBs 105 or UEs 102 operating in accordance with 3GPP standards, 5G standards, NR standards and/or other standards. However, embodiments of those methods are not limited to just those eNBs 104, gNBs 105 or UEs 102 and may also be practiced on other devices, such as a Wi-Fi access point (AP) or user station (STA). In addition, the methods 600, 700, 800 and other methods described herein may be practiced by wireless devices configured to operate in other suitable types of wireless communication systems, including systems configured to operate according to various IEEE standards such as IEEE 802.11. The methods 600, 700, 800 may also be applicable to an apparatus of a UE 102, an apparatus of an eNB 104, an apparatus of a gNB 105 and/or an apparatus of another device described above.

It should also be noted that embodiments are not limited by references herein (such as in descriptions of the methods 600, 700 and 800 and/or other descriptions herein) to transmission, reception and/or exchanging of elements such as frames, messages, requests, indicators, signals or other elements. In some embodiments, such an element may be generated, encoded or otherwise processed by processing circuitry (such as by a baseband processor included in the processing circuitry) for transmission. The transmission may be performed by a transceiver or other component, in some cases. In some embodiments, such an element may be decoded, detected or otherwise processed by the processing circuitry (such as by the baseband processor). The element may be received by a transceiver or other component, in some cases. In some embodiments, the processing circuitry and the transceiver may be included in a same apparatus. The scope of embodiments is not limited in this respect, however, as the transceiver may be separate from the apparatus that comprises the processing circuitry, in some embodiments.

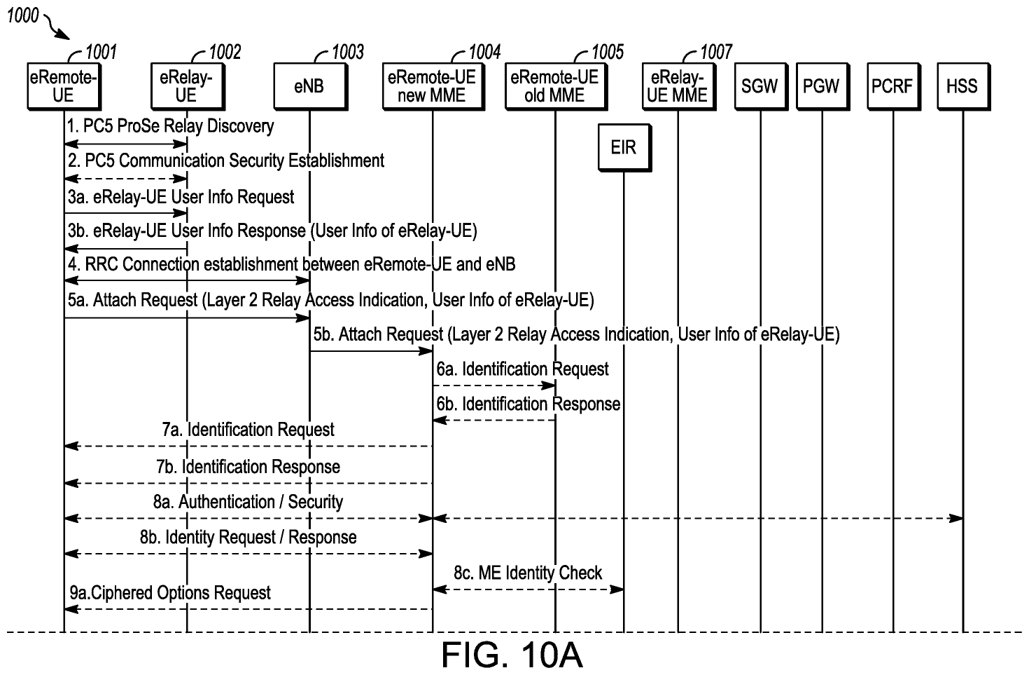

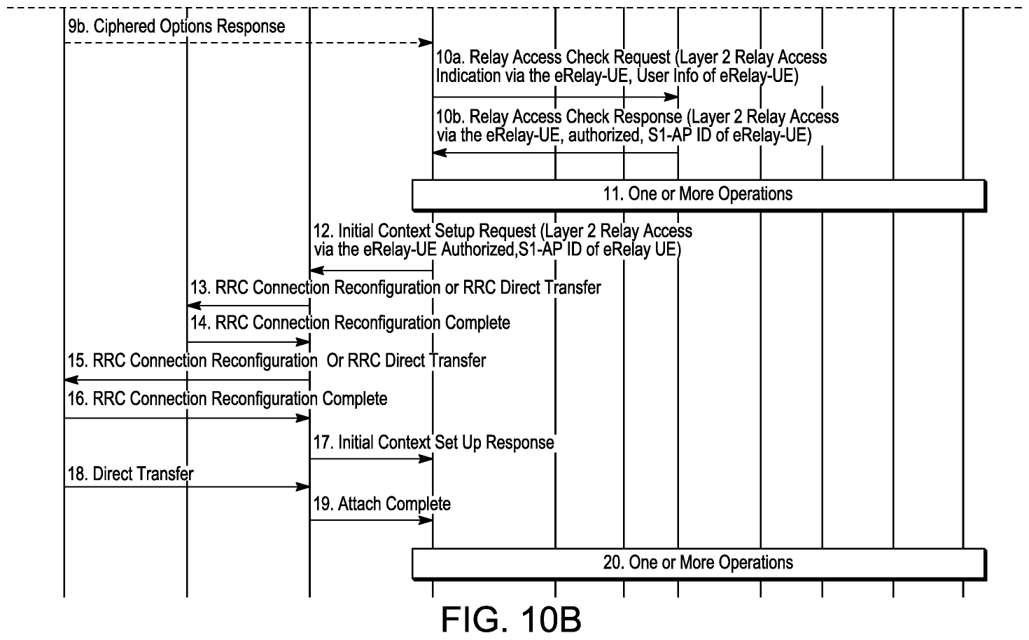

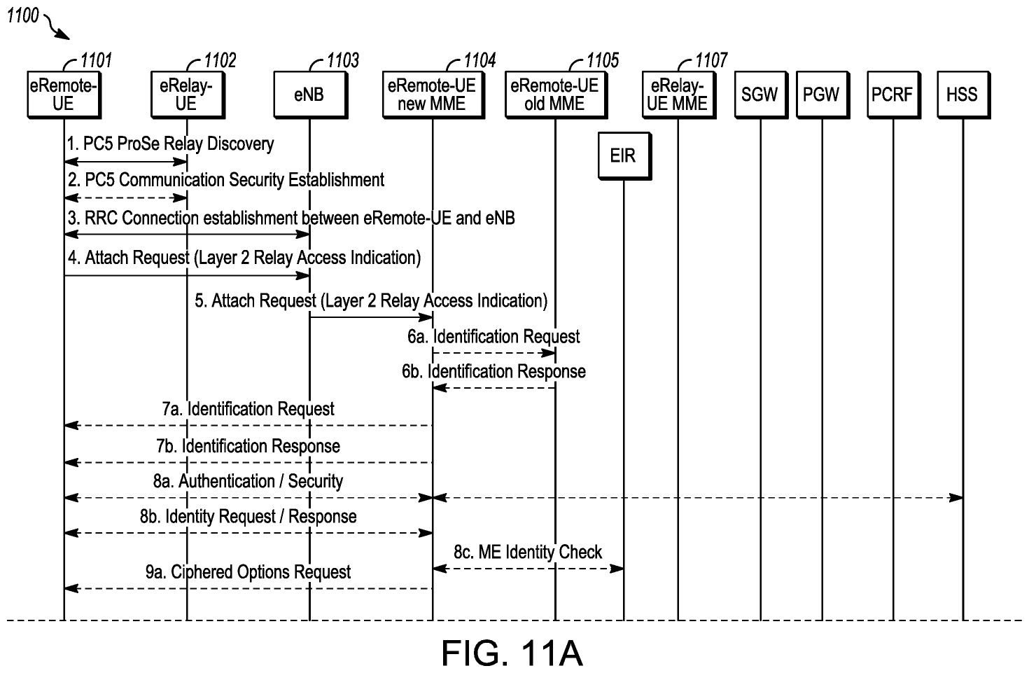

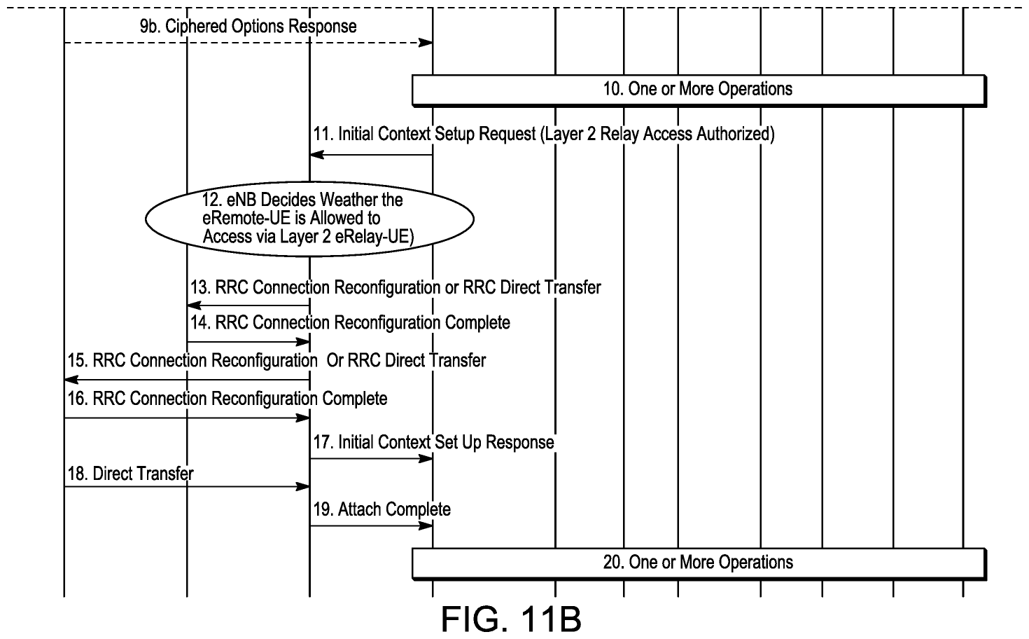

FIG. 9 illustrates example devices that may perform one or more operations in accordance with some embodiments. FIG. 10A and FIG. 10B illustrate example operations in accordance with some embodiments. FIG. 11A and FIG. 11B illustrate example operations in accordance with some embodiments. It should be noted that the examples shown in FIGS. 9, 10A, 10B, 11A, and 11B may illustrate some or all of the concepts and techniques described herein in some cases, but embodiments are not limited by the examples. For instance, embodiments are not limited by the name, number, type, size, ordering, arrangement of elements (such as devices, operations, messages and/or other elements) shown in FIGS. 9, 10A, 10B, 11A, and 11B. Although some of the elements shown in the examples of FIGS. 9, 10A, 10B, 11A, and 11B may be included in a 3GPP LTE standard, 5G standard, NR standard and/or other standard, embodiments are not limited to usage of such elements that are included in standards.

The methods 600, 700, 800 may be described in terms of the devices (eRemote UE 901, eRelay UE 902, eNB 903, MME 904) shown in FIG. 9 for clarity, but it is understood that embodiments are not limited to performance of the operations of the methods 600, 700, 800 by those devices shown in FIG. 9. In some embodiments, one or more devices and/or components described herein may perform one or more of the operations of the methods 600, 700, 800 (and/or other methods). In some embodiments, one or more devices and/or components shown in the figures (including but not limited to FIG. 1A, FIB. 1B, and FIGS. 2-5) described herein may perform one or more of the operations of the methods 600, 700, 800 (and/or other methods).

At operation 605, the eRemote UE 901 may exchange one or more proximity services (ProSe) discovery messages with an eRelay UE 902 for an establishment of a direct communication between the eRemote UE 901 and the eRelay UE 902. The ProSe discovery messages may be included in a 3GPP standard, in some embodiments. It should be noted that embodiments are not limited to usage of ProSe discovery messages in this operation and in other operations described herein, as any suitable messages may be used.

In some embodiments, the eRemote UE 901 may transmit one or more ProSe discovery messages to the eRelay UE 902. In some embodiments, the eRemote UE 901 may receive one or more ProSe discovery messages from the eRelay UE 902.

At operation 610, the eRemote UE 901 may transmit, to an eRelay UE 902, an eRelay user information request message to request user information from the eRelay UE 902. The eRelay user information request message may be included in a 3GPP standard, in some embodiments. It should be noted that embodiments are not limited to usage of the eRelay user information request message in this operation and in other operations described herein, as any suitable messages may be used.

In some embodiments, the eRemote UE 901 may transmit the eRelay user information request message in accordance with the direct communication between the eRemote UE 901 and the eRelay UE 902.

At operation 615, the eRemote UE 901 may receive, from the eRelay UE 902, an eRelay user information response message that includes user information of the eRelay UE 902. The eRelay user information response message may be included in a 3GPP standard, in some embodiments. It should be noted that embodiments are not limited to usage of the eRelay user information response message in this operation and in other operations described herein, as any suitable messages may be used.

In some embodiments, the user information may include a globally unique temporary identifier (GUTI) of the eRelay UE 902.

At operation 620, the eRemote UE 901 may transmit an attach request message to the eNB 903. The attach request message may be included in a 3GPP standard, in some embodiments. It should be noted that embodiments are not limited to usage of the attach request message in this operation and in other operations described herein, as any suitable messages may be used.

In some embodiments, the attach request message may indicate one or more of: a request to communicate with the eNB 903 in accordance with a relay arrangement that includes transmission of data packets by the eRemote UE 901 to the eRelay UE 902 to be forwarded to the eNB 903; whether the relay arrangement is a layer-2 relay arrangement; at least a portion of the user information of the eRelay UE 901; and/or other information.

In some embodiments, the attach request message may include a UE network capability information element (IE) that includes: a proximity-based services (ProSe) indicator that indicates whether the eRemote UE 901 supports ProSe; a ProSe relay layer indicator that indicates whether the relay arrangement is a layer-2 relay arrangement; and/or other information.

At operation 625, the eRemote UE 901 may transmit data packets to the eRelay UE 902. In some embodiments, the data packets may include sequence numbers for reassembly of the data packets at the eRelay UE 902 before relay to the eNB 903.

In some embodiments, if the relay arrangement is indicated to be a layer-2 relay arrangement, the eRemote UE 901 may, as part of the layer-2 relay arrangement: transmit data packets to the eRelay UE 902 that include sequence numbers for reassembly of the data packets at the eRelay UE 902 before relay to the eNB 903.

In some embodiments, the layer-2 relay arrangement may include transmission of the data packets by the eRemote UE 901 to the eRelay UE 902 in accordance with the direct communication between the eRemote UE 901 and the eRelay UE 902.

In some embodiments, an apparatus of an eRemote UE 901 may comprise memory. The memory may be configurable to store at least a portion of the user information of the eRelay UE 902. The memory may store one or more other elements and the apparatus may use them for performance of one or more operations. The apparatus may include processing circuitry, which may perform one or more operations (including but not limited to operation(s) of the method 600 and/or other methods described herein). The processing circuitry may include a baseband processor. The baseband circuitry and/or the processing circuitry may perform one or more operations described herein, including but not limited to encoding of the attach request message. The apparatus may include a transceiver to transmit the attach request message. The transceiver may transmit and/or receive other blocks, messages and/or other elements.

At operation 705, the eRelay UE 902 may exchange one or more proximity services (ProSe) discovery messages with an eRemote UE 901 for an establishment of a direct communication between the eRemote UE 901 and the eRelay UE 902. In some embodiments, the eRelay UE 902 may transmit one or more ProSe discovery messages to the eRemote UE 901. In some embodiments, the eRelay UE 902 may receive one or more ProSe discovery messages from the eRemote UE 901.

At operation 710, the eRelay UE 902 may receive, from the eRemote UE 901, an eRelay user information request message that requests user information from the eRelay UE 902.

At operation 715, the eRelay UE 902 may transmit, to the eRemote UE 901, an eRelay user information response message that includes user information of the eRelay UE 902. In some embodiments, the user information may include a GUTI of the eRelay UE 902.

At operation 720, the eRelay UE 902 may receive, from the eNB 903, a radio resource control (RRC) configuration message that indicates a layer-2 relay arrangement wherein the eRelay UE 902 is to operate as a relay between the eRemote UE 901 and the eNB 903. The RRC configuration message may be included in a 3GPP standard, in some embodiments. It should be noted that embodiments are not limited to usage of the RRC configuration message in this operation and in other operations described herein, as any suitable messages may be used.

At operation 725, the eRelay UE 902 may decode data packets received from the eRemote UE 901. At operation 730, the eRelay UE 902 may reassemble the decoded data packets in accordance with sequence numbers of the decoded packets. At operation 735, the eRelay UE 902 may transmit and/or forward the reassembled packets to the eNB 903. In some embodiments, one or more of operations 725, 730, 735 may be performed as part of the layer-2 relay arrangement, although the scope of embodiments is not limited in this respect.

In some embodiments, the eRelay UE 902 may, as part of the layer-2 relay arrangement, receive the packets from the eRemote UE 901 in accordance with the direct communication between the eRemote UE 901 and the eRelay UE 902.

In some embodiments, the eRelay UE 902 may transmit an attach request message to the eNB 903. In some embodiments, the attach request message may indicate one or more of: a request to communicate with the eNB 903 in accordance with a relay arrangement that includes transmission of data packets by the eRemote UE 901 to the eRelay UE 902 to be forwarded to the eNB 903; whether the relay arrangement is a layer-2 relay arrangement; at least a portion of the user information of the eRelay UE 901; and/or other information. The attach request message may be included in a 3GPP standard, in some embodiments. It should be noted that embodiments are not limited to usage of the attach request message in this operation and in other operations described herein, as any suitable messages may be used.

In some embodiments, an apparatus of an eRelay UE 902 may comprise memory. The memory may be configurable to store at least a portion of the user information of the eRelay UE 902. The memory may store one or more other elements and the apparatus may use them for performance of one or more operations. The apparatus may include processing circuitry, which may perform one or more operations (including but not limited to operation(s) of the method 700 and/or other methods described herein). The processing circuitry may include a baseband processor. The baseband circuitry and/or the processing circuitry may perform one or more operations described herein, including but not limited to encoding of the eRelay user information response message. The apparatus may include a transceiver to transmit the eRelay user information response message. The transceiver may transmit and/or receive other blocks, messages and/or other elements.

At operation 805, the eNB 903 may receive an attach request message. In some embodiments, the eNB 903 may receive the attach request message from an eRemote UE 901. In some embodiments, the eNB 903 may receive the attach request message from an eRelay UE 902. In some embodiments, the attach request message may indicate a layer-2 relay between the eRemote UE 901 and an eRelay UE 902, although the scope of embodiments is not limited in this respect. In some embodiments, the attach request message may indicate one or more of: a request to communicate with the eNB 903 in accordance with a layer-2 relay arrangement, wherein the eRelay UE 902 is to operate as a relay between the eRemote UE 901 and the eNB 903; user information of the eRelay UE 902; and/or other information.

At operation 810, the eNB 903 may forward at least a portion of the attach request message to an MME 904. In some embodiments, the eNB 903 may encode at least a portion of the attach request in a message to be forwarded to the MME 904.

At operation 815, the eNB 903 may receive, from the MME 904, an initial context setup request message. In some embodiments, the initial context setup request message may indicate whether the eRemote UE 901 is authorized for the layer-2 relay arrangement. In some embodiments, the initial context setup request message may indicate whether the eRelay UE 902 is authorized for the layer-2 relay arrangement. In some embodiments, the initial context setup request message may indicate whether the eRemote UE 901 is authorized for the layer-2 relay arrangement and may further indicate whether the eRelay UE 902 is authorized for the layer-2 relay arrangement. The initial context setup request message may be included in a 3GPP standard, in some embodiments. It should be noted that embodiments are not limited to usage of the initial context setup request message in this operation and in other operations described herein, as any suitable messages may be used.

In some embodiments, an authorization may include one or more of: an authorization for the eRemote UE 901 to access the eNB 903 via the eRelay UE 902 in accordance with a layer-2 relay; and an authorization for the eRelay UE 902 to operate in accordance with the layer-2 relay.

In some embodiments, the initial context setup request message may further indicate an S1-AP identifier (S1-AP ID) of the eRelay UE 902. In some embodiments, if the initial context setup request message indicates that the eRemote UE 901 is authorized for the layer-2 relay arrangement, the initial context setup request message may further indicate an S1-AP identifier (S1-AP ID) of the eRelay UE 902.

At operation 820, the eNB 903 may determine whether to support the layer-2 relay arrangement. In a non-limiting example, the initial context setup request message may further indicate a maximum number of eRemote UEs 901 that the eRelay UE 902 is permitted to support. The eNB 903 may determine, based at least partly on the maximum number of eRemote UEs 901 that the eRelay UE 902 is permitted to support, whether to support the layer-2 arrangement indicated by the attach request message.

It should be noted that some embodiments of the method 800 may not necessarily include operation 820. For instance, the MME 904 may determine whether the layer-2 relay arrangement is to be supported, and may indicate this decision in the initial context setup request message.

At operation 825, the eNB 903 may transmit an RRC message to the eRelay UE 902. In some embodiments, the RRC message may indicate the layer-2 relay arrangement, although the scope of embodiments is not limited in this respect.

At operation 830, the eNB 903 may receive first data packets from the eRelay UE 902 that have been forwarded from the eRemote UE 901. At operation 835, the eNB 903 may transmit second data packets to the eRelay UE 902 to be forwarded to the eRemote UE 901. In some embodiments, one or more of operations 830 and 835 may be performed as part of the layer-2 relay arrangement, although the scope of embodiments is not limited in this respect.

In some embodiments, an apparatus of an eNB 903 may comprise memory. The memory may be configurable to store at least a portion of the user information of the eRelay UE 902. The memory may store one or more other elements and the apparatus may use them for performance of one or more operations. The apparatus may include processing circuitry, which may perform one or more operations (including but not limited to operation(s) of the method 800 and/or other methods described herein). The processing circuitry may include a baseband processor. The baseband circuitry and/or the processing circuitry may perform one or more operations described herein, including but not limited to decoding of the attach request message. The apparatus may include a transceiver to receive the attach request message. The transceiver may transmit and/or receive other blocks, messages and/or other elements.

In some embodiments, during an eRelay-UE discovery procedure, the eRelay-UE 902 may announce its layer 2 relay capability. This may be referred to, in some cases, as “Model A”. In some embodiments, during the eRelay-UE discovery procedure, the eRemote-UE 901 may solicit a layer 2 relay capable eRelay-UE 902. This may be referred to, in some cases, as “Model B”.

After the layer 2 eRelay-UE 902 is selected by the eRemote-UE 901, the eRemote-UE 901 may request user information of the eRelay-UE 902 (such as GUTI and/or other) from the eRelay-UE 902.

During an attach procedure of the eRemote-UE 901, the eRemote-UE 901 may provide the user information of the selected eRelay-UE 902 to the MME 904. During an AKA procedure, the eRemote-UE 901 and the MME 904 may determine a PC5 UE Security Context, in some cases. Later, the MME 904 may check whether the eRemote-UE 901 is permitted to access the network via the eRelay-UE 902. If such access is permitted, the MME 904 associated with the eRelay-UE 902 may provide an S1-AP eNB ID of the eRelay-UE 902 to the MME 904 of the eRemote-UE 901. In some embodiments, the eNB 903 may store the relay association between the eRemote-UE 901 an eRelay-UE 902 by usage of the S1-AP eNB ID of the eRelay-UE 902. The eNB 903 may handle requested EPS bearers by the eRemote-UE 901. In some embodiments, the eNB 903 may send the a PC5 Security Context of the eRemote-UE 901 to the eRelay-UE 902 in RRC Connection Reconfiguration message. This may be performed, in some cases, in order to enable the PC5 signaling security protection.

In some embodiments, for the “Model A”, a PC5_DISCOVERY message for UE-to-Network Relay Discovery Announcement may include an indicator of a relay layer capability (such as layer 2 and/or layer 3). In some embodiments, for the “Model B”, a PC5_DISCOVERY message for UE-to-Network Relay Discovery Solicitation may include an indicator of a relay layer capability (such as layer 2 and/or layer 3) desired by the eRemote-UE 901. It should be noted that the “Model A” and “Model B” described herein may be included in a 3GPP standard, although the scope of embodiments is not limited in this respect.

In some embodiments, a message may include an indicator related to a relay layer capability. In some embodiments, a NAS message (such as an attach request, a tracking area update (TAU) and/or other) may include such an indicator. In some embodiments, an S1-AP message may include such an indicator.

In some embodiments, a NAS message may include a UE Network Capability information element (IE). The NAS message and/or UE network capability IE may be included in a 3GPP standard, although the scope of embodiments is not limited in this respect. In some embodiments, the UE network capability IE may include one or more of the following: a “ProSe” indicator that may indicate whether ProSe is supported and/or similar information; a “ProSe direct discovery” indicator (such as a ProSe-dd bit) that may indicate whether ProSe direct discovery is supported and/or similar information; a “ProSe direct communication” indicator (such as a ProSe-dc bit) that may indicate whether ProSe direct communication is supported and/or similar information; a “ProSe UE-to-network relay” indicator (such as a ProSe-relay bit) that may indicate a capability to act as a ProSe UE-to-network relay and/or similar information; a “ProSe relay layer” indicator; and/or other. In some embodiments, the ProSe relay layer indicator may indicate one or more of: support for layer 2 relay by the eRemote UE 901, support for layer 2 relay by the eRelay UE 902, support for layer 3 relay by the eRemote UE 901, support for layer 3 relay by the eRelay UE 902, a type of relay (layer 2 or layer 3) supported by the eRemote UE 901, a type of relay (layer 2 or layer 3) supported by the eRelay UE 902, a type of relay (layer 2 or layer 3) desired and/or requested by the eRemote UE 901, a type of relay (layer 2 or layer 3) desired and/or requested by the eRelay UE 902, similar information and/or other information.

In some embodiments, a UE (including but not limited to a ProSe-enabled UE) may include the ProSe indicator (that indicates a capability of ProSe) as part of the “UE Network Capability” in an Attach Request message. The MME 904 may store this information for ProSe operation. If the MME 904 is configured to indicate “ProSe authorised” to E-UTRAN, the UE may be enabled for ProSe capability and may also be authorized to use ProSe direct services based on subscription data. The MME 904 may (and/or shall) include a “ProSe authorized” indication in a message (including but not limited to an S1 AP Initial Context Setup Request) that may indicate which of the ProSe direct services the UE is authorized to use. If a “ProSe authorized” status of the UE indicates that the UE is not authorized to use or act as either layer 2 or layer 3 UE-to-Network Relay, then the eNB 903 may refrain from authorization of the UE to use radio resources for Relay.

In some embodiments, a message (including but not limited to the S1-AP message) may include a ProSe Relay Layer indicator. In some embodiments, a “ProSe authorized” indication in an S1 AP message may include one or more of: a “ProSe Direct Discovery” indicator, which may indicate whether the UE is authorized for ProSe direct discovery and/or similar information; a “ProSe Direct Communication” indicator, which may indicate whether the UE is authorized for ProSe direct communication and/or similar information; a “ProSe UE-to-Network Relaying” indicator, which may indicate whether the UE is authorized to act as ProSe UE-to-network relay and/or similar information; a “ProSe Relay Layer” indicator; and/or other. In some embodiments, the ProSe relay layer indicator may indicate one or more of: support for layer 2 relay by the eRemote UE 901, support for layer 2 relay by the eRelay UE 902, support for layer 3 relay by the eRemote UE 901, support for layer 3 relay by the eRelay UE 902, a type of relay (layer 2 or layer 3) supported by the eRemote UE 901, a type of relay (layer 2 or layer 3) supported by the eRelay UE 902, a type of relay (layer 2 or layer 3) desired and/or requested by the eRemote UE 901, a type of relay (layer 2 or layer 3) desired and/or requested by the eRelay UE 902, similar information and/or other information.

In some embodiments, an authentication and authorization procedure for an eRelay-UE 902 to be a layer 2 relay UE may be performed. The eRelay-UE 902 may perform one or more operations of an attach procedure included in a 3GPP standard, although the scope of embodiments is not limited in this respect. One or more of those operations (of the attach procedure) may be related to authentication and/or authorization. In an Attach Request message, the eRelay-UE 902 may indicate a layer 2 relay capability. In a non-limiting example, the ProSe relay layer indicator may be used for this purpose.

In some embodiments, the MME 904 may store the layer 2 relay capability indication. From a downloaded subscriber profile, the MME 904 may check if the eRelay-UE 902 is authorized to be a layer 2 relay as follows. If the UE is enabled for layer 2 relay and is also authorized to be a layer 2 relay based on the subscription data, the MME 904 may (and/or shall) include, in a message (including but not limited to an S1 AP Initial Context Setup Request message), an indication of layer 2 relay authorized in the “ProSe authorized” indication and maximum number of eRemote-UE 901 permitted to be served. The eNB 903 may authorize the UE to use radio resources for layer 2 Relay. Otherwise (if the UE is not enabled for layer 2 relay or is not authorized to be a layer 2 relay based on the subscription data), the MME 904 may refrain from inclusion of an indication of layer 2 relay authorized in the “ProSe authorised” in the S1 AP Initial Context Setup Request. If a “ProSe authorised” status if the UE indicates that the UE is not authorized to act as a layer 2 Relay, then the eNB 903 may refrain from authorization of the UE to use radio resources for layer 2 Relay.

In some embodiments, an authentication and/or authorization procedure for an eRemote-UE 901 to use a layer 2 relay with an eRelay-UE 902 may be performed. In some embodiments, the layer 2 Relay Access Authorization may be controlled by the MME 904. In order for the network to know which eRelay-UE 902 the eRemote-UE 901 will connect to, the eRemote-UE 901 may, in some cases, use user information of the eRelay-UE 902 (such as GUTI and/or other). The eRemote-UE 901 may request the user information from the eRelay-UE 902 after a layer 2 relay discovery procedure. Then during the attach procedure of the eRemote-UE 901, the eRemote-UE 901 may include the user information of the eRelay-UE 902 in the Attach Request message. The MME 904 of the eRemote-UE 901 may check with the MME 904 of the eRelay-UE 902 about whether the eRemote-UE 901 is permitted to perform indirect 3GPP communication via this eRelay-UE 902.

Such a procedure may use one or more of the operations illustrated in FIG. 10A and FIG. 10B. In descriptions herein, a combination of FIG. 10A and FIG. 10B may be referred to as “FIG. 10.” It should be noted that embodiments are not limited to the type of messages shown in FIG. 10, the names of messages shown in FIG. 10 or the ordering of messages shown in FIG. 10. Some embodiments may not necessarily include all operations shown in FIG. 10. Some embodiments may include one or more operations not shown in FIG. 10.

As indicated by “1” in FIG. 10, during the PC5 ProSe Relay discovery procedure, the eRemote-UE 1001 may discover the layer 2 eRelay-UE 1002. As indicated by “2” in FIG. 10, PC5 communication security may be established using techniques such as ECCSI and SAKKE, which may be included in a 3GPP standard, although the scope of embodiments is not limited in this respect. As indicated by “3a” in FIG. 10, the eRemote-UE 1001 may send an eRelay-UE User information request message to the eRelay-UE 1002. As indicted by “3b” in FIG. 10, the eRelay-UE 1002 may respond with an eRelay-UE user information response message that may include user information. For instance, a GUTI and/or other information may be included. As indicated by “4” in FIG. 10, an RRC connection may be established between the eRemote-UE 1001 and the eNB 1003.

As indicated by “5a” in FIG. 10, the eRemote-UE 1001 may send the attach request message to the eNB 1003. The Layer 2 relay access indication and/or the user information of the eRelay-UE 1002 may be included in the Attach Request message. As indicated by “5b” in FIG. 10, the eNB 1003 may select an MME (such as 1004) for the eRemote-UE 1001 and may forward the attach request message to the selected MME 1004. The attach request message may include the Layer 2 relay access indication and/or the user information of the eRelay-UE 1002. In some cases, the MME 1004 of the eRemote-UE 1001 may be different from the MME 1007 of the eRelay-UE 1002. In some cases, however, one MME may communicate with both the eRelay UE and the eRemote UE 1001.

One or more of the operations labeled as “6a,” “6b,” “7a,” “7b,” “8a,” “8b,” “9a,” and “9b” may be similar to operations included in a 3GPP standard, although the scope of embodiments is not limited in this respect.

As indicated by “10a” in FIG. 10, from the GUTI of the eRelay-UE 1002, the MME 1004 may know the MME 1007 of the eRelay-UE 1002. The MME 1004 of the eRemote-UE 1001 may send a relay access check request message to the MME 1007 of the eRelay-UE 1002 to see if the eRemote-UE 1001 is permitted to access the network via the layer 2 eRelay-UE by including the Layer 2 relay access indication and/or the user information of the eRelay-UE 1002.

As indicated by “10b” in FIG. 10, if the eRelay-UE 1002 is authorized to be a layer 2 Relay, the MME 1007 of the eRelay-UE 1002 may respond with a Relay Access Check Response message to the MME 1004 of the eRemote-UE 1001, which may include an indication of Layer 2 relay access authorization and/or an S1-AP eNB ID of the eRelay UE 1002.

As indicated by “11” in FIG. 10, one or more operations, including but not limited to one or more operations of a 3GPP standard, may be performed.

As indicated by “12” in FIG. 10, the MME 1004 of the eRemote-UE 1001 may send an Initial Context Setup Request to the eNB 1003. The message may include the indication of Layer 2 relay access authorization and/or the S1-AP eNB ID of the eRelay UE 1002. The eNB 1003 may allocate the UE S1-AP eNB ID for the eRemote-UE 1001 and may store the relay relationship between the eRemote-UE 1001 and the eRelay-UE 1002. If there is an available EPS bearer of eRelay-UE 1002 in the eNB 1003 (bearers which may be reused by the requested EPS bearer of the eRemote-UE 1001), the eNB 1003 may modify a QoS rule correlated with this EPS Bearer to accommodate the combined QoS request. Otherwise, the eNB 1003 may establish a new EPS bearer for the eRelay-UE 1002 to accommodate the EPS bearer request of the eRemote-UE. The newly established EPS bearer may not necessarily be correlated with PDN connections of the eRelay-UE 1002.

As indicated by “13” in FIG. 10, the eNB 1003 may send an RRC Connection Reconfiguration message to the eRelay-UE 1002. As indicated by “14” in FIG. 10, the eRelay-UE 1002 may reply with the RRC Connection Reconfiguration Complete message to the eNB 1003. As indicated by “15” in FIG. 10, once the LTE-Uu resource is established between the eRelay-UE 1002 and the eNB 1003, the eNB 1003 may send an RRC Connection Reconfiguration message to the eRemote-UE 1001 to reconfigure the RRC resource between the eRemote-UE 1001 and the eNB 1003. As indicated by “16” in FIG. 10, the eRemote-UE 1001 may reply with the RRC Connection Reconfiguration Complete message to eNB 1003.

The operations indicated by “17”-“20” may be similar to operations of a 3GPP standard, although the scope of embodiments is not limited in this respect.

In some embodiments, Layer 2 Relay Access Authorization may be controlled by an eNB. Such a procedure may use one or more of the operations illustrated in FIG. 11A and FIG. 11B. In descriptions herein, a combination of FIG. 11A and FIG. 11B may be referred to as “FIG. 11.” It should be noted that embodiments are not limited to the type of messages shown in FIG. 11, the names of messages shown in FIG. 11 or the ordering of messages shown in FIG. 11. Some embodiments may not necessarily include all operations shown in FIG. 11. Some embodiments may include one or more operations not shown in FIG. 11.

As indicated by “1” in FIG. 11, during the PC5 ProSe Relay discovery procedure, the eRemote-UE 1101 may discover the layer 2 eRelay-UE 1102. As indicated by “2” in FIG. 11, PC5 communication security may be established using ECCSI and SAKKE. Such techniques may be included in a 3GPP standard, although the scope of embodiments is not limited in this respect. As indicated by “3” in FIG. 11, an RRC connection may be established between the eRemote-UE 1101 and the eNB 1103. As indicated by “4” in FIG. 11, the eRemote-UE 1101 may send the Attach Request message to the eNB 1103. The Layer 2 relay access indication may be included in the Attach Request message. The eNB 1103 may select an MME 1104 for the eRemote-UE 1101 and may forward (as indicated by “5” in FIG. 11) the Attach Request message to the selected MME 1104. The forwarded message may include the Layer 2 relay access indication. In some cases, the MME 1104 of the eRemote-UE 1101 may be different from the MME 1107 of the eRelay-UE 1102. In some cases, however, one MME may communicate with both the eRelay UE 1102 and the eRemote UE 1101.

One or more of the operations labeled as “6a,” “6b,” “7a,” “7b,” “8a,” “8b,” “9a,” “9b” and “10” may be similar to operations included in a 3GPP standard, although the scope of embodiments is not limited in this respect.

Based on the indication of the UE and the subscription information of the eRemote-UE 1101, the MME 1104 of the eRemote-UE 1101 may decide whether the layer 2 relay access is authorized for this eRemote-UE 1101. If it is allowed, the MME 1104 of the eRemote-UE 1101 may send (as indicated by “11” in FIG. 11) the Initial Context Setup Request message to the eNB 1103. The message may include an indication of Layer 2 relay access authorization.

As indicated by “12” in FIG. 11, the eNB 1103 may decide whether the eRemote-UE 1101 is permitted to access the network via the layer 2 eRelay-UE 1102 based on the received “ProSe Authorised” in S1-AP messages for both the eRemote-UE 1101 and the eRelay-UE 1102. As indicated by “13” in FIG. 11, the eNB 1103 may send an RRC Connection Reconfiguration message to the eRelay-UE 1102. As indicated by “14” in FIG. 11, the eRelay-UE 1102 may reply with the RRC Connection Reconfiguration Complete to the eNB 1103. As indicated by “15” in FIG. 11, once the LTE-Uu resource is established between the eRelay-UE 1102 and the eNB 1103, the eNB 1103 may send an RRC Connection Reconfiguration message to the eRemote-UE 1101 to reconfigure the RRC resource between the eRemote-UE 1101 and the eNB 1103. As indicated by “16” in FIG. 11, the eRemote-UE 1101 may reply with the RRC Connection Reconfiguration Complete message to the eNB 1103.

One or more of the operations labeled as “17,” “18,” “19,” and “20” may be similar to operations included in a 3GPP standard, although the scope of embodiments is not limited in this respect.

In some embodiments, for a discovery procedure, for the “Model A”, a PC5_DISCOVERY message for UE-to-Network Relay Discovery Announcement may indicate a Relay layer (such as layer-2, layer-3 and/or other) capability. For the “Model B”, a PC5_DISCOVERY message for UE-to-Network Relay Discovery Solicitation may indicate a desired Relay layer (such as layer-2, layer-3 and/or other) capability of an eRemote UE 901.

In some embodiments, during an attach procedure, the eRelay-UE 902 may include the layer 2 Relay capability indication in the UE Network Capability IE if the UE is capable of layer 2 relay. The MME 904 may include the layer 2 Relaying authorized indication in the “ProSe Authorized” indication in the S1 AP Initial Context Setup message to eNB 903 if the UE is capable of layer 2 Relay and authorized to be a layer 2 Relay in the subscription profile.

In some embodiments, the eRemote-UE 901 may request user information of the eRelay-UE 902 from the eRelay-UE 902. In some embodiments, the eRelay-UE 902 may respond to the eRemote-UE 901 with the user information (such as the GUTI) of the eRelay-UE 902. In some embodiments, in the Attach Request message, the eRemote-UE 901 may include an indication of layer 2 relay access and the user information of the eRelay-UE 902. In some embodiments, the MME 904 of the eRemote-UE 901 may send a Relay Access Check Request (which may include the Layer 2 relay access indication, user information of the eRelay-UE 902 and/or other information) to the MME 904 of the eRelay-UE 902 to see if the eRemote-UE 901 is allowed to access the network via the eRelay-UE 902. In some embodiments, if permitted, the MME 904 of the eRelay-UE 902 may reply with a Relay Access Check Response (which may include an indication of layer 2 relay access authorization, an S1-AP eNB ID of the eRelay UE 902 and/or other information). In some embodiments, the MME 904 of the eRemote-UE 901 may include, in in the Initial Context Setup Request message to eNB 903, the indication of layer 2 relay access authorization, the S1-AP eNB ID of the eRelay UE 902 and/or other information.

In some embodiments, the eNB 903 may allocate the UE S1-AP eNB ID for the eRemote-UE 901 and may store a relay relationship between the eRemote-UE 901 and the eRelay-UE 902. If there is an available EPS bearer of the eRelay-UE 902 in the eNB 903, which can be reused by the requested EPS bearer of the eRemote-UE 901, the eNB 903 may modify a QoS rule correlated with this EPS Bearer to accommodate the combined QoS request. Otherwise, the eNB 903 may establish a new EPS bearer for the eRelay-UE 902 to accommodate the bearer request of the eRemote-UE 901. The newly established EPS bearer may not necessarily be correlated with a PDN connection of the eRelay-UE 902.

In some embodiments, eRemote-UE Authorization may be controlled by the eNB 903. In some embodiments, the eRemote-UE 901 may send the Attach Request message to the eNB 903. The Layer 2 relay access indication may be included in the Attach Request message. In some embodiments, the eNB 903 may select an MME 904 for the eRemote-UE 901 and may forward the Attach Request message to the selected MME 904 (which may include the Layer 2 relay access indication, in some embodiments). In some embodiments, based on the indication of the eRemote UE 901 and subscription information of the eRemote-UE, the MME 904 of the eRemote-UE 901 may decide whether the layer 2 relay access is authorized for this eRemote-UE 901. If such access is permitted, the MME 904 of the eRemote-UE 901 may send the Initial Context Setup Request to the eNB 903 (which may include an indication of whether Layer 2 relay access is authorized). In some embodiments, the eNB 903 may decide whether the eRemote-UE 901 is permitted to access the network via the layer 2 eRelay-UE 902 based on the received “ProSe Authorised” in S1-AP messages for both the eRemote-UE 901 and the eRelay-UE 902.

In Example 1, a User Equipment (UE) may be configurable to operate as an eRemote UE. An apparatus of the UE may comprise memory. The apparatus may further comprise processing circuitry. The processing circuitry may be configured to encode, for transmission to an eRelay UE, an eRelay user information request message to request user information from the eRelay UE. The processing circuitry may be further configured to decode, from the eRelay UE, an eRelay user information response message that includes user information of the eRelay UE. The processing circuitry may be further configured to encode, for transmission to an Evolved Node-B (eNB), an attach request message that indicates: a request to communicate with the eNB in accordance with a relay arrangement that includes transmission of data packets by the eRemote UE to the eRelay UE to be forwarded to the eNB, whether the relay arrangement is a layer-2 relay arrangement, and at least a portion of the user information of the eRelay UE. The memory may be configured to store at least a portion of the user information of the eRelay UE.

In Example 2, the subject matter of Example 1, wherein the attach request message may include a UE network capability information element (IE) that includes: a proximity-based services (ProSe) indicator that indicates whether the eRemote UE supports ProSe, and a ProSe relay layer indicator that indicates whether the relay arrangement is a layer-2 relay arrangement.

In Example 3, the subject matter of one or any combination of Examples 1-2, wherein if the relay arrangement is indicated to be a layer-2 relay arrangement, the processing circuitry is further configured to, as part of the layer-2 relay arrangement, encode data packets for transmission to the eRelay UE. The data packets may include sequence numbers for reassembly of the data packets at the eRelay UE before relay to the eNB.

In Example 4, the subject matter of one or any combination of Examples 1-3, wherein the processing circuitry may be further configured to encode, for transmission, one or more proximity services (ProSe) discovery messages for an establishment of a direct communication between the eRemote UE and the eRelay UE.

In Example 5, the subject matter of one or any combination of Examples 1-4, wherein the layer-2 relay arrangement may include transmission of the data packets by the eRemote UE to the eRelay UE in accordance with the direct communication between the eRemote UE and the eRelay UE.

In Example 6, the subject matter of one or any combination of Examples 1-5, wherein the processing circuitry may be further configured to encode the eRelay user information request message for transmission in accordance with the direct communication between the eRemote UE and the eRelay UE.

In Example 7, the subject matter of one or any combination of Examples 1-6, wherein the user information may include a globally unique temporary identifier (GUTI) of the eRelay UE.

In Example 8, the subject matter of one or any combination of Examples 1-7, wherein the apparatus may further include a transceiver to transmit the attach request message.

In Example 9, the subject matter of one or any combination of Examples 1-8, wherein the processing circuitry may include a baseband processor to encode the attach request message.

In Example 10, a computer-readable storage medium may store instructions for execution by one or more processors to perform operations for communication by a User Equipment (UE). The UE may be configurable to operate as an eRelay UE. The operations may configure the one or more processors to decode, from an eRemote UE, an eRelay user information request message that requests user information from the eRelay UE. The operations may further configure the one or more processors to encode, for transmission to the eRemote UE, an eRelay user information response message that includes user information of the eRelay UE. The operations may further configure the one or more processors to decode, from an Evolved Node-B (eNB), a radio resource control (RRC) configuration message that indicates a layer-2 relay arrangement wherein the eRelay UE is to operate as a relay between the eRemote UE and the eNB. The operations may further configure the one or more processors to, as part of the layer-2 relay arrangement: decode packets from the eRemote UE; reassemble the decoded packets in accordance with sequence numbers of the decoded packets; and encode the reassembled packets for relay to the eNB.

In Example 11, the subject matter of Example 10, wherein the operations may further configure the one or more processors to encode, for transmission, one or more proximity services (ProSe) discovery messages for an establishment of a direct communication between the eRemote UE and the eRelay UE.

In Example 12, the subject matter of one or any combination of Examples 10-11, wherein the operations may further configure the one or more processors to, as part of the layer-2 relay arrangement, decode the packets received from the eRemote UE in accordance with the direct communication between the eRemote UE and the eRelay UE.

In Example 13, the subject matter of one or any combination of Examples 10-12, wherein the user information may include a globally unique temporary identifier (GUTI) of the eRelay UE.

In Example 14, an apparatus of an Evolved Node-B (eNB) may comprise memory. The apparatus may further comprise processing circuitry. The processing circuitry may be configured to decode, from an eRemote User Equipment (UE), an attach request message that indicates: a request to communicate with the eNB in accordance with a layer-2 relay arrangement, wherein a eRelay UE is to operate as a relay between the eRemote UE and the eNB, and user information of the eRelay UE. The processing circuitry may be further configured to encode at least a portion of the attach request in a message to be forwarded to a mobile management entity (MME). The processing circuitry may be further configured to decode, from the MME, an initial context setup request message that indicates whether the eRemote UE is authorized for the layer-2 relay arrangement. The memory may be configured to store at least a portion of the user information of the eRelay UE.

In Example 15, the subject matter of Example 14, wherein, if the initial context setup request message indicates that the eRemote UE is authorized for the layer-2 relay arrangement, the initial context setup request message may further indicate an S1-AP identifier (S1-AP ID) of the eRelay UE.

In Example 16, the subject matter of one or any combination of Examples 14-15, wherein the processing circuitry may be further configured to encode, for transmission to the eRelay UE, a radio resource control (RRC) configuration message that indicates the layer-2 relay arrangement.

In Example 17, the subject matter of one or any combination of Examples 14-16, wherein the processing circuitry may be further configured to, as part of the layer-2 relay arrangement: decode first data packets from the eRelay UE that have been forwarded from the eRemote UE; and encode second data packets for transmission to the eRelay UE to be forwarded to the eRemote UE.

In Example 18, a computer-readable storage medium may store instructions for execution by one or more processors to perform operations for communication by an Evolved Node-B (eNB). The operations may configure the one or more processors to decode, from an eRelay User Equipment (UE), an attach request message that indicates: a request to communicate with the eNB in accordance with a layer-2 relay arrangement, wherein the eRelay UE is to operate as a relay between an eRemote UE and the eNB, and user information of the eRelay UE. The operations may further configure the one or more processors to encode at least a portion of the attach request in a message to be forwarded to a mobile management entity (MME). The operations may further configure the one or more processors to decode, from the MME, an initial context setup request message that indicates whether the eRelay UE is authorized for the layer-2 relay arrangement.

In Example 19, the subject matter of Example 18, wherein the initial context setup request message may further indicate a maximum number of eRemote UEs that the eRelay UE is permitted to support. The operations may further configure the one or more processors to determine, based at least partly on the maximum number of eRemote UEs that the eRelay UE is permitted to support, whether to support the layer-2 arrangement indicated by the attach request message.

In Example 20, the subject matter of one or any combination of Examples 18-19, wherein the user information includes a globally unique temporary identifier (GUTI) of the eRelay UE.

In Example 21, a User Equipment (UE) may be configurable to operate as an eRelay UE. An apparatus of the UE may comprise means for decoding, from an eRemote UE, an eRelay user information request message that requests user information from the eRelay UE. The apparatus may further comprise means for encoding, for transmission to the eRemote UE, an eRelay user information response message that includes user information of the eRelay UE. The apparatus may further comprise means for decoding, from an Evolved Node-B (eNB), a radio resource control (RRC) configuration message that indicates a layer-2 relay arrangement wherein the eRelay UE is to operate as a relay between the eRemote UE and the eNB. The apparatus may further comprise means for, as part of the layer-2 relay arrangement: decoding packets from the eRemote UE; reassembling the decoded packets in accordance with sequence numbers of the decoded packets; and encoding the reassembled packets for relay to the eNB.

In Example 22, the subject matter of Example 21, wherein the apparatus may further comprise means for encoding, for transmission, one or more proximity services (ProSe) discovery messages for an establishment of a direct communication between the eRemote UE and the eRelay UE.

In Example 23, the subject matter of one or any combination of Examples 21-22, wherein the apparatus may further comprise means for, as part of the layer-2 relay arrangement, decoding the packets received from the eRemote UE in accordance with the direct communication between the eRemote UE and the eRelay UE.

In Example 24, the subject matter of one or any combination of Examples 21-23, wherein the user information may include a globally unique temporary identifier (GUTI) of the eRelay UE.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1. An apparatus of a User Equipment (UE), the UE configurable to operate as an eRemote UE, the apparatus comprising: memory; and processing circuitry, configured to:
encode, for transmission to an eRelay UE, an eRelay user information request message to request user information from the eRelay UE;
decode, from the eRelay UE, an eRelay user information response message that includes user information of the eRelay UE;
encode, for transmission to an Evolved Node-B (eNB), an attach request message that indicates:
a request to communicate with the eNB in accordance with a relay arrangement that includes transmission of data packets by the eRemote UE to the eRelay UE to be forwarded to the eNB,
whether the relay arrangement is a layer-2 relay arrangement, and
at least a portion of the user information of the eRelay UE,
wherein the memory is configured to store at least a portion of the user information of the eRelay UE.

2. The apparatus according to claim 1, wherein:
the attach request message includes a UE network capability information element (IE) that includes:
a proximity-based services (ProSe) indicator that indicates whether the eRemote UE supports ProSe, and
a ProSe relay layer indicator that indicates whether the relay arrangement is a layer-2 relay arrangement.

3. The apparatus according to claim 1, wherein if the relay arrangement is indicated to be a layer-2 relay arrangement, the processing circuitry is further configured to, as part of the layer-2 relay arrangement:
encode data packets for transmission to the eRelay UE,
wherein the data packets include sequence numbers for reassembly of the data packets at the eRelay UE before relay to the eNB.

4. The apparatus according to claim 1, the processing circuitry further configured to:
encode, for transmission, one or more proximity services (ProSe) discovery messages for an establishment of a direct communication between the eRemote UE and the eRelay UE.

5. The apparatus according to claim 1, wherein the layer-2 relay arrangement includes transmission of the data packets by the eRemote UE to the eRelay UE in accordance with the direct communication between the eRemote UE and the eRelay UE.

6. The apparatus according to claim 1, the processing circuitry further configured to:
encode the eRelay user information request message for transmission in accordance with the direct communication between the eRemote UE and the eRelay UE.

7. The apparatus according to claim 1, wherein the user information includes a globally unique temporary identifier (GUTI) of the eRelay UE.

8. The apparatus according to claim 1, wherein the apparatus further includes a transceiver to transmit the attach request message.

9. The apparatus according to claim 1, wherein the processing circuitry includes a baseband processor to encode the attach request message.

10. A computer-readable storage medium that stores instructions for execution by one or more processors to perform operations for communication by a User Equipment (UE), the UE configurable to operate as an eRelay UE, the operations to configure the one or more processors to:
decode, from an eRemote UE, an eRelay user information request message that requests user information from the eRelay UE;
encode, for transmission to the eRemote UE, an eRelay user information response message that includes user information of the eRelay UE;
decode, from an Evolved Node-B (eNB), a radio resource control (RRC) configuration message that indicates a layer-2 relay arrangement wherein the eRelay UE is to operate as a relay between the eRemote UE and the eNB; and
as part of the layer-2 relay arrangement:
decode packets from the eRemote UE;
reassemble the decoded packets in accordance with sequence numbers of the decoded packets; and
encode the reassembled packets for relay to the eNB.

11. The computer-readable storage medium according to claim 10, the operations to further configure the one or more processors to:
encode, for transmission, one or more proximity services (ProSe) discovery messages for an establishment of a direct communication between the eRemote UE and the eRelay UE.

12. The computer-readable storage medium according to claim 10, the operations to further configure the one or more processors to:
as part of the layer-2 relay arrangement, decode the packets received from the eRemote UE in accordance with the direct communication between the eRemote UE and the eRelay UE.

13. The computer-readable storage medium according to claim 12, wherein the user information includes a globally unique temporary identifier (GUTI) of the eRelay UE.

14. An apparatus of an Evolved Node-B (eNB), the apparatus comprising: memory; and processing circuitry, configured to:
decode, from an eRemote User Equipment (UE), an attach request message that indicates:
a request to communicate with the eNB in accordance with a layer-2 relay arrangement, wherein a eRelay UE is to operate as a relay between the eRemote UE and the eNB, and
user information of the eRelay UE;
encode at least a portion of the attach request in a message to be forwarded to a mobile management entity (MME); and
decode, from the MME, an initial context setup request message that indicates whether the eRemote UE is authorized for the layer-2 relay arrangement,
wherein the memory is configured to store at least a portion of the user information of the eRelay UE.

15. The apparatus according to claim 14, wherein:
if the initial context setup request message indicates that the eRemote UE is authorized for the layer-2 relay arrangement, the initial context setup request message further indicates:
an S1-AP identifier (S1-AP ID) of the eRelay UE.

16. The apparatus according to claim 14, the processing circuitry further configured to:
encode, for transmission to the eRelay UE, a radio resource control (RRC) configuration message that indicates the layer-2 relay arrangement.

17. The apparatus according to claim 16, the processing circuitry further configured to, as part of the layer-2 relay arrangement:
decode first data packets from the eRelay UE that have been forwarded from the eRemote UE; and
encode second data packets for transmission to the eRelay UE to be forwarded to the eRemote UE.

18.-20. (canceled)
